(19) United States
(12) Patent Application Publication
(10) Pub. No.: US 2021/0084861 A1
(43) Pub. Date: Mar. 25, 2021

(54) Litter Box Lift Assembly

(71) Applicants: Louise Steinbach, Georgetown, TX (US); Richard Steinbach, Georgetown, TX (US)

(72) Inventors: Louise Steinbach, Georgetown, TX (US); Richard Steinbach, Georgetown, TX (US)

(21) Appl. No.: 16/575,480

(22) Filed: Sep. 19, 2019

(51) Int. Cl. A01K 1/01; F16M 11/38

(52) U.S. Cl. CPC A01K 1/0107; H01H 3/14; F16M 11/38

(57) ABSTRACT

A litter box lift assembly for PURPOSE includes a litter box for containing kitty litter. A ramp is positionable on a support surface thereby facilitating a feline to walk up the ramp. A lifting unit is positioned in the ramp. The lifting unit is actuatable between a lifted position and a lowered position. A panel is coupled to the lifting unit. The litter box is positionable on the panel such that the litter box is lifted or lowered by the lifting unit.

In this way a user can lift the litter box without bending over.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to lift devices and more particularly pertains to a new lift device for elevating a kitty litter box thereby facilitating a user to lift the kitty litter box without bending over.

### (2) Description of Related Art Including Information Disclosed Under 37 CFR 1.97 and 1.98

The prior art relates to lift devices.

### BRIEF SUMMARY OF THE INVENTION

An embodiment of the disclosure meets the needs presented above by generally comprising a litter box for containing kitty litter. A ramp is positionable on a support surface thereby facilitating a feline to walk up the ramp. A lifting unit is positioned in the ramp. The lifting unit is actuatable between a lifted position and a lowered position. A panel is coupled to the lifting unit. The litter box is positionable on the panel such that the litter box is lifted or lowered by the lifting unit. In this way a user can lift the litter box without bending over.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a litter box lift assembly according to an embodiment of the disclosure.

FIG. 2 is a back phantom view of an embodiment of the disclosure.

FIG. 3 is a perspective in-use view of an embodiment of the disclosure.

FIG. 4 is a top view of an embodiment of the disclosure.

FIG. 5 is a left side phantom view of an embodiment of the disclosure showing a scissor lift in a collapsed position.

FIG. 6 is a left side phantom view of an embodiment of the disclosures showing a scissor lift moving into an extended position.

### DETAILED DESCRIPTION OF THE INVENTION

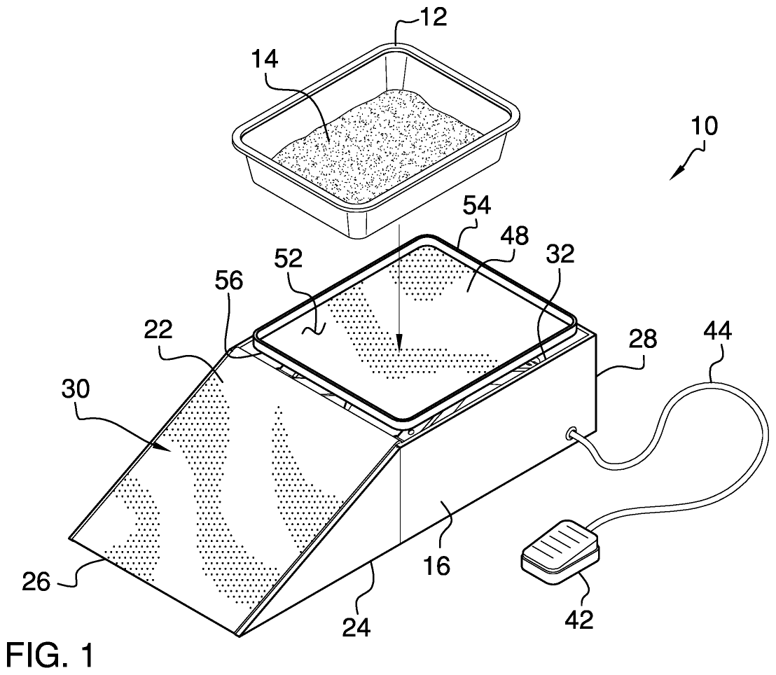

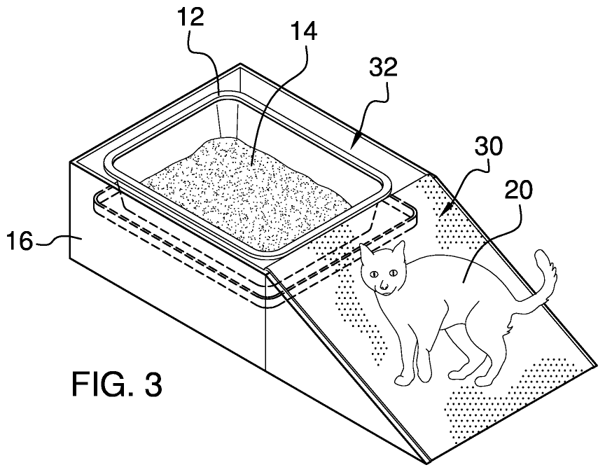

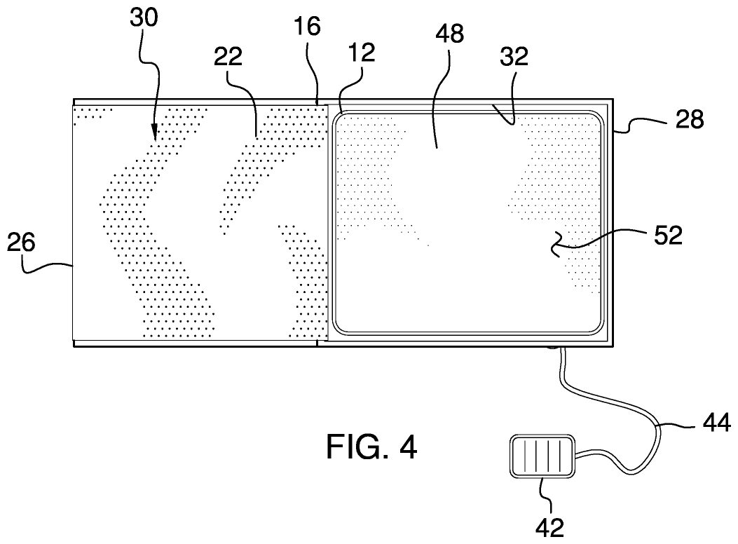

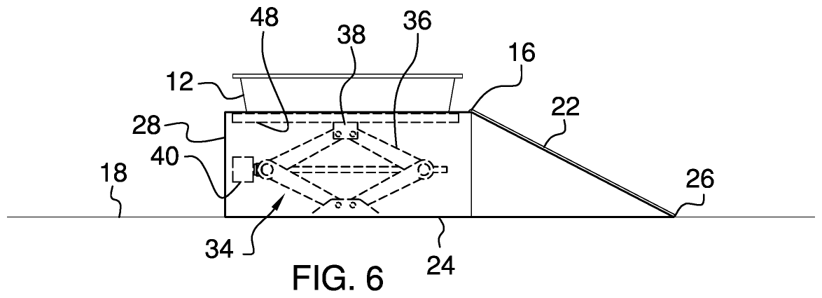

With reference now to the drawings, and in particular to FIGS. 1 through 6 thereof, a new lift device embodying the principles and concepts of an embodiment of the disclosure and generally designated by the reference numeral 10 will be described.

As best illustrated in FIGS. 1 through 6, the litter box lift assembly 10 generally comprises a litter box 12 for containing kitty litter 14. A ramp 16 is provided and the ramp 16 is positionable on a support surface 18 thereby facilitating a feline 20 to walk up the ramp 16. The ramp 16 has a top wall 22, a bottom wall 24, a first end 26 and a second end 28. The top wall 22 has a sloped portion 30 and an opening 32 extending into an interior of the ramp 16. The sloped portion 30 angles upwardly from the first end 26 toward the opening 32, and the opening 32 extends between the second end 28 and the sloped portion 30. Additionally, the sloped portion 30 has a textured surface to inhibit the feline 20 from slipping.

A lifting unit 34 is positioned in the ramp 16 and the lifting unit 34 is actuatable between a lifted position and a lowered position. The lifting unit 34 comprises a scissor lift 36 that is positioned in the ramp 16. Additionally, the scissor lift 36 is positioned beneath the opening 32 in the top wall 22 of the ramp 16. The scissor lift 36 is positionable in an extended position having a top end 38 of the scissor lift 36 extending upwardly through the opening 32 in the top wall 22 of the ramp 16. The scissor lift 36 is positionable in a collapsed position having the top end 38 of the scissor lift 36 being positioned beneath a threshold of the opening 32.

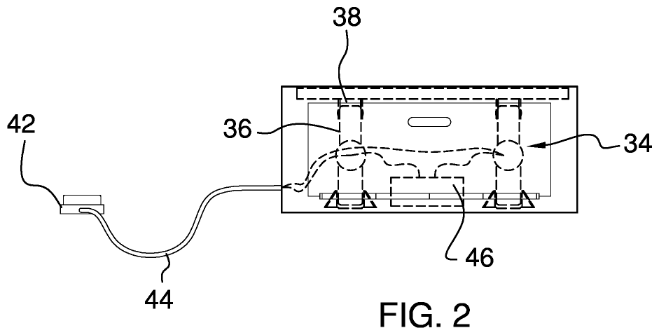

The lifting unit 34 includes an actuator 40 that is coupled to the scissor lift 36. The actuator 40 is turned on in a first condition to urge the scissor lift 36 into the extended position. Additionally, the actuator 40 is turned on into a second condition to urge the scissor lift 36 into the collapsed position. The actuator 40 may be an electric motor, a linear actuator or any other type of powered actuator that can operate the scissor lift 36. The scissor lift 34 may achieve a height of approximately 36.0 inches when the scissor lift 34 is in the extended position. As is most clearly shown in FIG. 2, a pair of the scissor lifts 34 may be provided.

The lifting unit 34 includes a foot switch 42 that is remotely positioned with respect to the ramp 16 to be stepped on by a user. The foot switch 42 is positionable in a first position, a second position or a third position. Additionally, the foot switch 42 is biased into the third position. A conductor 44 is electrically coupled between the foot switch 42 and the actuator 40 such that the foot switch 42 is in electrical communication with the actuator 40. The actuator 40 is turned on into the first condition when the foot switch 42 is positioned in the first position. Additionally, the actuator 40 is turned on into the second condition when the foot switch 42 is positioned in the second position. The actuator 40 is turned off when the foot switch 42 is in the third position.

A power supply 46 is coupled to the ramp 16, the power supply 46 is electrically coupled to the actuator 40 and the power supply 46 comprises at least one battery. The power supply 46 may alternatively include a power cord that extends away from the ramp 16. The power cord may be plugged into a power source comprising a female electrical outlet. A panel 48 is coupled to the lifting unit 34. The litter box 12 is positionable on the panel 48 such that the litter box 12 is lifted or lowered by the lifting unit 34.

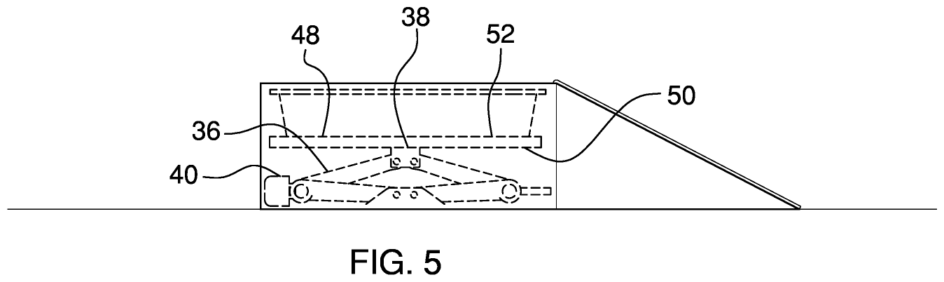

The panel 48 has a bottom surface 50 and a top surface 52. The bottom surface 50 is coupled to the top end 38 of the scissor lift 36 and the litter box 12 is positionable on the top surface 52. The panel 48 has a lip 54 extending upwardly from the top surface 52. The lip 54 is coextensive with a perimeter edge 56 of the panel 48 to inhibit the litter box 12 from sliding off of the panel 48. The top surface 52 of the panel 48 is textured to inhibit the litter from sliding. As is most clearly shown in FIG. 5, the litter box 12 may be aligned with the threshold of the opening 32 in the top wall 22 of the ramp 16 when the scissor lift 36 is in the collapsed position.

In use, the user steps on the foot switch 42 to lift the litter box 12 when the user wants to empty the litter box 12. In this way the litter box 12 is positioned at a height that does not require the user to bend over in order to pick up the litter box 12. Thus, an elderly user, a physical disabled user or any other user is assisted with picking up the litter box 12. The litter box 12 is placed on the panel 48 when the kitty litter 14 has been changed and the foot switch 42 is stepped on to lower the litter box 12. Thus, the litter box 12 is positioned to allow the feline 20 to enter the litter box 12 when the feline 20 walks up the ramp 16.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A litter box lift assembly being configured to elevate a litter box so a user does not have to bend over to empty the litter box, said assembly comprising:
a litter box for containing kitty litter;
a ramp being positionable on a support surface thereby facilitating a feline to walk up said ramp;
a lifting unit being positioned in said ramp, said lifting unit being actuatable between a lifted position and a lowered position; and
a panel being coupled to said lifting unit, said litter box being positionable on said panel such that said litter box is lifted or lowered by said lifting unit thereby facilitating a user to pick up said litter box without bending over.

2. The assembly according to claim 1, wherein said ramp has a top wall, a bottom wall, a first end and a second end, said top wall having a sloped portion and an opening extending into an interior of said ramp, said sloped portion angling upwardly from said first end toward said opening, said opening extending between said second end and said sloped portion.

3. The assembly according to claim 2, wherein said lifting unit comprises a scissor lift being positioned in said ramp, said scissor lift being positioned beneath said opening in said top wall of said ramp, said scissor lift being positionable in an extended position having a top end of said scissor lift being extended upwardly through said opening in said top wall of said ramp, said scissor lift being positionable in a collapsed position having said top end of said scissor lift being positioned beneath a threshold of said opening.

4. The assembly according to claim 3, wherein said lifting unit includes an actuator being coupled to said scissor lift, said actuator being turned on in a first condition having said actuator urging said scissor lift into said extended position, said actuator being turned on into a second condition having said actuator urging said scissor lift into said collapsed position.

5. The assembly according to claim 4, wherein said lifting unit includes a foot switch being remotely positioned with respect to said ramp wherein said foot switch is configured to be stepped on by a user, said foot switch being positionable in a first position, a second position or a third position, said foot switch being biased into said third position.

6. The assembly according to claim 5, wherein said lifting unit includes a conductor being electrically coupled between said foot switch and said actuator such that said foot switch is in electrical communication with said actuator, said actuator being turned on into said first condition when said foot switch is positioned in said first position, said actuator being turned on into said second condition when said foot switch is positioned in said second position, said actuator being turned off when said foot switch is in said third position.

7. The assembly according to claim 6, wherein said lifting unit includes a power supply being coupled to said ramp, said power supply being electrically coupled to said actuator, said power supply comprising at least one battery.

8. The assembly according to claim 3, wherein said panel has a bottom surface and a top surface, said bottom surface being coupled to said top end of said scissor lift, said litter box being positionable on said top surface, said panel having a lip extending upwardly from said top surface, said lip being coextensive with a perimeter edge of said panel to inhibit said litter box from sliding off of said panel.

9. A litter box lift assembly being configured to elevate a litter box so a user does not have to bend over to empty the litter box, said assembly comprising:
a litter box for containing kitty litter;
a ramp being positionable on a support surface thereby facilitating a feline to walk up said ramp, said ramp having a top wall, a bottom wall, a first end and a second end, said top wall having a sloped portion and an opening extending into an interior of said ramp, said sloped portion angling upwardly from said first end toward said opening, said opening extending between said second end and said sloped portion;
a lifting unit being positioned in said ramp, said lifting unit being actuatable between a lifted position and a lowered position, said lifting unit comprising:
a scissor lift being positioned in said ramp, said scissor lift being positioned beneath said opening in said top wall of said ramp, said scissor lift being positionable in an extended position having a top end of said scissor lift being extended upwardly through said opening in said top wall of said ramp, said scissor lift being positionable in a collapsed position having said top end of said scissor lift being positioned beneath a threshold of said opening;
an actuator being coupled to said scissor lift, said actuator being turned on in a first condition having said actuator urging said scissor lift into said extended position, said actuator being turned on into a second condition having said actuator urging said scissor lift into said collapsed position;
a foot switch being remotely positioned with respect to said ramp wherein said foot switch is configured to be stepped on by a user, said foot switch being positionable in a first position, a second position or a third position, said foot switch being biased into said third position;
a conductor being electrically coupled between said foot switch and said actuator such that said foot switch is in electrical communication with said actuator, said actuator being turned on into said first condition when said foot switch is positioned in said first position, said actuator being turned on into said second condition when said foot switch is positioned in said second position, said actuator being turned off when said foot switch is in said third position; and
a power supply being coupled to said ramp, said power supply being electrically coupled to said actuator, said power supply comprising at least one battery; and
a panel being coupled to said lifting unit, said litter box being positionable on said panel such that said litter box is lifted or lowered by said lifting unit thereby facilitating a user to lift said litter box without bending over, said panel having a bottom surface and a top surface, said bottom surface being coupled to said top end of said scissor lift, said litter box being positionable on said top surface, said panel having a lip extending upwardly from said top surface, said lip being coextensive with a perimeter edge of said panel to inhibit said litter box from sliding off of said panel.
